(19) United States
(12) Patent Application Publication
(10) Pub. No.: US 2003/0226020 A1
(43) Pub. Date: Dec. 4, 2003

(54) Protecting digital broadcast content from unauthorized redistribution

(76) Inventors: Michael S. Ripley, Hillsboro, OR (US); C. Brendan S. Traw, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/164,979

(22) Filed: Jun. 4, 2002

(51) Int. Cl. H04L 9/00

(52) U.S. Cl. 713/176

(57) ABSTRACT

Protection of content by deterring unauthorized redistribution may be accomplished by at least one of three methods in a consumer modulator device. A first method protects content from unauthorized redistribution by other devices in a content protection system by verifying authenticity of a validated flag, the validated flag being at least a portion of the content, and by removing the validated flag when the validated flag is not authentic. A second method protects content from unauthorized redistribution by other devices by checking whether the content includes a broadcast flag, the broadcast flag being at least a portion of the content, and by removing the broadcast flag from the content when the broadcast flag is detected in the content. A third method protects content from unauthorized redistribution by other devices by checking whether the content includes a watermark, the watermark being at least a portion of the content, by checking whether the content includes a broadcast flag when the watermark is found in the content, the broadcast flag being at least a portion of the content, and by removing the broadcast flag from the content when the watermark found in the content is more restrictive than a broadcast watermark.

### BACKGROUND

1. Field

The present invention relates generally to content protection and security in computer and consumer electronics systems and, more specifically, to protecting digital broadcast content from unauthorized redistribution.

2. Description

Typical digital content protection solutions use a combination of technical and legal mechanisms to protect content against use that is inconsistent with the terms under which the content was obtained from the content owner or authorized distributor. The technical mechanisms usually take the form of a cryptographic protocol through which content is distributed or stored in an encrypted form. Access to the cryptographic keying material necessary to decrypt the protected content is subject to a license. The license is a legal tool to enforce the conditions under which such access is provided. The license includes rules governing robust implementation and continued protection of content that is received subject to the license and subsequently stored or retransmitted. A state is typically associated with the content that governs how the content may be used. This state information is stored in a manner that ensures that the integrity of the state information is maintained. The state information may be carried along with the content, with the information cryptographically protected. Additionally, the state information may be embedded within the content using a watermark technology.

Watermarking is a technique whereby information is embedded into content in such a way that is transparent to users of the content, is difficult to remove from the content, and can be robustly detected in the content by specialized hardware or software. In some systems, the watermark data may indicate conditions and requirements constraining use of the content, including constraints specific to copying. A recording device that is compliant with such a system may be required to detect the watermark in content that is to be copied. If the watermark is present, the device only makes such a copy in a manner that is permitted by the watermark. If the watermark data indicates that a copy is not permitted, then the recording device does not make the copy. Products that license a content protection solution involving watermarking can be compelled through the license to respond to such watermark information, which is carried with the content independent of the content's encrypted digital, unencrypted digital, or analog representation.

Efforts are underway to protect terrestrial digitally broadcast audio-visual content, such as digital television (DTV) content that is broadcast using the Advanced Television Standards Committee (ATSC) standard. For several reasons, including regulatory ones, such content needs to be broadcast in unencrypted (i.e., unprotected) form. Nevertheless, there is strong desire on the part of content providers to protect such content from unauthorized redistribution.

One known proposal for protecting content is shown in FIG. 1. In this scheme, a broadcast flag (BF) and/or broadcast watermark (BW) are used as a means for signaling application of protection against unauthorized redistribution for unencrypted digital terrestrial broadcast content. The BF consists of one or more digital bits of information and has the property of being difficult to remove from the modulated signal (e.g., the ATSC signal), but easy to remove once the content has been demodulated. The BW comprises specific watermark data to signal protection of broadcast digital content.

As shown in FIG. 1, in-the-clear terrestrial digital broadcast content 10 is received by a tuner 12. Received content 14 is terrestrial digital broadcast content that has been processed by a digital demodulator (e.g., within tuner 12). Marked content 18 is received content that has been screened by a transport stream processor 16 for either a BF or a BW and determined to contain such signaling means. Unmarked content 20 is received content that has been screened for either the BF or BW and determined to not contain such signaling means. Tuner 12 and transport stream processor 16 are typically resident within a consumer electronics device such as a consumer receiver (not shown in FIG. 1).

In the known proposal, a set of compliance and robustness rules govern the secure handling of the unencrypted terrestrial digital broadcast content received by consumer electronics products. For example, such products should ensure that the received content is screened for either the BF or the BW (at the election of the product manufacturer), ensure that marked content leaves the product only by authorized output ports or secure recording means, and be designed and manufactured to provide protection against unauthorized access prior to screening the BF or BW. Enforcement of such rules may be accomplished via licensing or government legislation and regulation.

Despite such a proposal, various avenues for attack against the content remain. Therefore, a need exists for an improved system to deter unauthorized redistribution of digital content.

### BRIEF DESCRIPTION OF THE DRAWINGS

The features and advantages of the present invention will become apparent from the following detailed description of the present invention in which:

FIG. 1 is a diagram of a prior art content protection system;

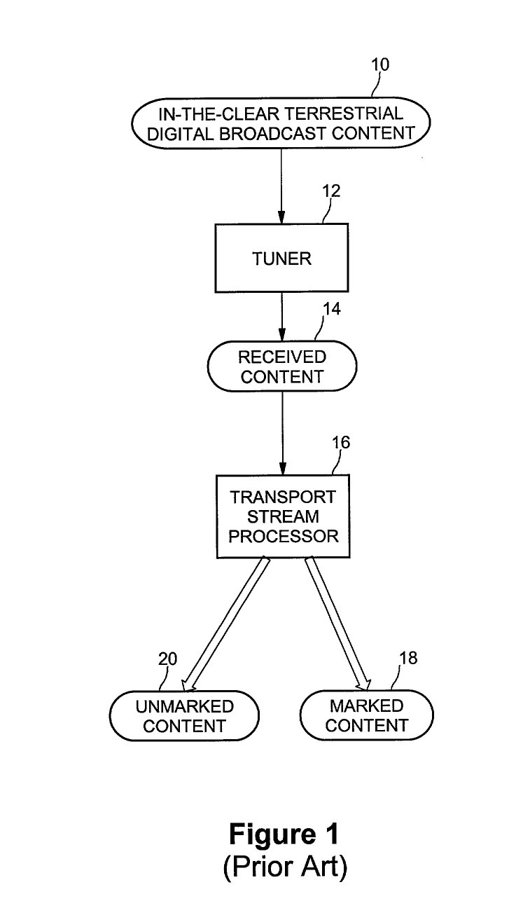

FIG. 2 is a diagram of a system for protecting digital broadcast content from unauthorized redistribution according to an embodiment of the present invention;

FIG. 3 is a flow diagram of validated flag processing in a consumer modulator device according to an embodiment of the present invention;

FIG. 4 is a flow diagram illustrating broadcast flag processing in a consumer modulator device according to an embodiment of the present invention; and

FIG. 5 is a flow diagram illustrating watermark processing in a consumer modulator device according to an embodiment of the present invention.

### DETAILED DESCRIPTION

An embodiment of the present invention is a method of protecting digital content in several usage scenarios. According to the embodiments of the present invention, protection logic within consumer modulators and/or consumer receivers may be modified to process modulated content, protected content, and clear content in various ways to improve security.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

In one known proposal for content protection, the proposal permits demodulators within consumer electronics equipment to respond to either a broadcast watermark (BW) or a broadcast flag (BF). The BW comprises a specific watermark to signal content protection for broadcast digital content. In the case where the BF is used, two attacks are possible. A first attack is to remove a legitimate BF from demodulated, unprotected content. The result of this “removal attack” is that such content will no longer signal the application of protection mechanisms (following re-modulation and subsequent demodulation). A second attack is to insert an illegitimate BF into un-modulated, restrictively watermarked content. An example of this would be the insertion of a BF into content containing a “copy never” watermark, such as digital versatile disk (DVD)-video content. If that content then gets modulated, subsequent demodulation of the content will invoke protection mechanisms signaled by the BF. One of those mechanisms would be protected transmission, such as to a recording device that implements a protected storage scheme. Because content arrives in protected form, a recording device may respond to the digital copy control information (digital CCI) associated with the protected transmission, instead of the “copy never” watermark (which the recording device would have screened for had the content arrived unprotected), when making a recording. As a result, this “insertion attack” circumvents the watermark-based recording and playback control mechanisms associated with known content protection solutions.

One approach to address both attacks would be for all demodulators to detect the BW (it is assumed that a watermark cannot be easily inserted or removed). However, this may be problematic, due to the high cost of including watermark detection functionality in consumer electronics devices, delays in defining a BW, and the desirability of a quick solution to the redistribution problem.

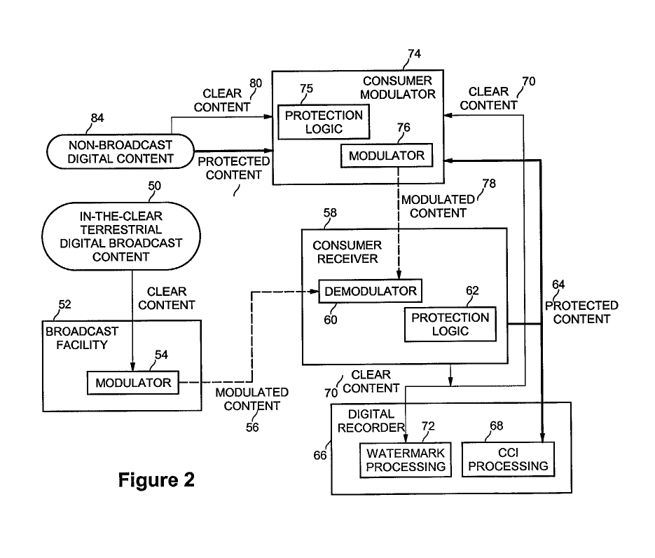

FIG. 2 is a diagram of a system according to an embodiment of the present invention. In-the-clear terrestrial digital broadcast content 50, in analog or digital form, may be received from any content source by broadcast facility 52 according to any manner of transmission or communication. At this point, the content is clear content (i.e., unprotected by encryption or another content protection mechanism). Content comprises any combination of audio, video, text, image, or other data. In one example, content comprises TV programming. Broadcast facility 52 may be any entity or organization to broadcast content. Modulator 54 may be included within broadcast facility 52 to modulate the in-the-clear terrestrial digital broadcast content onto a carrier signal, thereby forming modulated content 56. The modulated content may be broadcast via any suitable broadcast mechanism to any number of consumer receivers 58. In one embodiment, the content is in ATSC format.

A consumer receiver may comprise any consumer electronics device to receive the modulated content, such as a TV, a video cassette recorder (VCR), a personal video recorder (PVR) for storing content in digital form, an audio receiver, a tuner, a satellite receiver, a cable TV set-top box, a personal computer (PC), a home server, or other device. Each consumer receiver includes a demodulator 60 to demodulate the received signal. The demodulated content may be checked by protection logic 62 within the consumer receiver to determine if the content contains a BF and/or a BW.

In order to keep costs down for implementing a consumer receiver, it is desirable to require the protection logic within the consumer receiver to only check a single protection signaling mechanism (such as a single bit or flag) to signal the content protection mechanism. Accordingly, consumer receivers may not be designed to check for a BW. Instead, the consumer receiver may only check for a BF. Problems may result when the content includes a BF and a watermark that indicates protection that is more restrictive (e.g., no copies permitted) than that indicated by the BF.

Protection logic 62 within consumer receiver 58 checks for a BF. If a BF is present, then the demodulated content may be sent as protected content 64 to other devices, such as digital recorder 66, on permitted output ports and using permitted output methods. Digital recorder may then use copy control information (CCI) processing logic 68 to determine whether copying or retransmission of the protected content is allowed. If a BF is not present, the demodulated content may be sent as clear content 70. The clear content may be forwarded to watermark processing logic 72 within the digital recorder to determine if the content has a watermark embedded within it. If the content contains a watermark, the digital recorder may interpret the watermark to determine any further restrictions on copying or retransmission of the content.

Output data from consumer receiver 58 (such as protected content 64 and clear content 70) may in some cases be redirected to a device called a consumer modulator device 74. Consumer modulator comprises at least modulator 76, similar in function to modulator 54 within broadcast facility 52, to modulate either clear content or protected content into modulated content 78, and protection logic 75 to process a BF and/or a BW according to embodiments of the present invention. Consumer modulator may be incorporated into another consumer electronics device or may be a stand-alone device. Consumer modulator 74 may be any device supporting the functions described herein and available (via any distribution mechanism) to consumers, end-users, or other entities who consume content. Any modulated content 78 input to consumer receiver 58 may be processed in the same way as modulated content 56, despite the fact that the modulated content came from the consumer modulator and not the broadcast facility.

In one scenario, a hacker may obtain protected content 64 from the consumer receiver, parse the content to locate the BF, and remove the BF (thereby defeating the protection mechanism). Once the BF is removed during this removal attack, the content may be modulated by modulator 76 and transmitted to the consumer receiver. Since the BF is no longer in the content, the consumer receiver and digital recorder will treat the content as clear content and allow redistribution if no watermark prohibiting redistribution is contained in the content.

Clear content 80 and protected content 82 may also be obtained by the consumer modulator from non-broadcast digital content 84. In this scenario, a hacker may obtain protected content 82 from a DVD (for example), break the protection mechanism protecting the DVD content, convert the DVD content to ATSC format, and insert an illegitimate BF into un-modulated, restrictively watermarked content (such as DVD-video content containing a “copy never” watermark). The consumer modulator then modulates this content and the modulated content is transmitted to the consumer receiver. Since an illegitimate BF is now in the modulated content, the consumer receiver reads the BF such that the illegitimate BF takes precedence over the restrictive watermark in the overall content protection scheme. The consumer receiver can't distinguish this content from legitimate content received from the broadcast facility. The content is then considered to be protected content, and handled by CCI processing 68 rather than by watermark processing 72, within the digital recorder. If the content is clear content 80, the hacker may convert the clear content to ATSC format and insert the illegitimate BF into the clear content without needing to break the encryption mechanism of the content.

Deterrence of both the insertion and removal attacks described herein may be accomplished with at least one of the following methods according to embodiments of the present invention.

In a first method, instead of using a BF consisting of a single bit or flag, a validated flag (VF) may be used. The VF comprises a plurality of bits of data with special properties that enable the consumer modulator to verify that the VF was created by a legitimate and authorized entity and corresponds to the content that the VF accompanies. For example, a VF may comprise a digital signature that can be verified by the protection logic 75 of the consumer modulator, and may be cryptographically bound to certain critical portions of the content for which the VF was created. When using a VF, instead of having the consumer receiver 58 validate the VF (in place of the BF), a requirement may be imposed on the consumer modulator 74 to make the protection logic of the consumer modulator verify the authenticity of the VF. If the VF is determined by the consumer modulator to be invalid, then the protection logic of the consumer modulator must remove the VF.

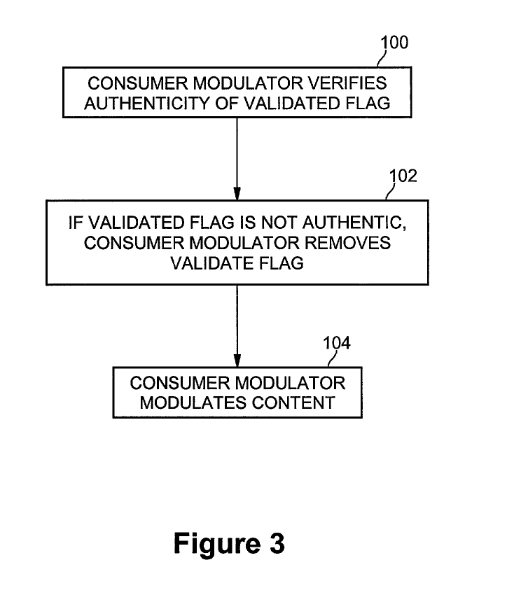

FIG. 3 is a flow diagram of validated flag processing in a consumer modulator according to an embodiment of the present invention. At block 100, the protection logic of the consumer modulator verifies the authenticity of the VF using known cryptographic techniques (e.g., using digital signatures). At block 102, if the VF is not authentic, the protection logic of the consumer modulator removes the VF from the content. At block 104, the consumer modulator modulates the edited content for subsequent transmission (e.g., to a consumer receiver).

The effect of this processing is that when the consumer receiver receives the modulated content, the consumer receiver can rely on the VF as legitimate because the modulated content was received either from broadcast facility 52 (such that modulated content is presumed to be valid) or consumer modulator 74 that has already checked the VF for authenticity.

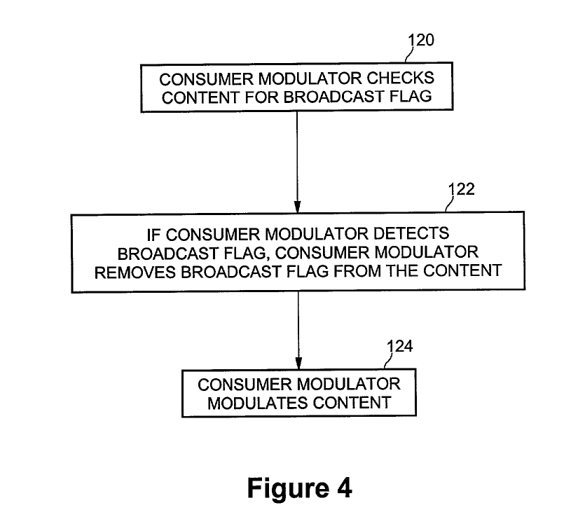

In a second method, a BF instead of a VF is used. The protection logic of the consumer modulator checks the content for the BF. If the protection logic of the consumer modulator detects the BF, the consumer modulator removes the BF from the content prior to modulation of the content. FIG. 4 is a flow diagram illustrating broadcast flag processing by a consumer modulator according to an embodiment of the present invention. At block 120, the protection logic of the consumer modulator checks the content for a broadcast flag (BF). If a BF is found in the content, the protection logic of the consumer modulator removes the BF at block 122. At block 124, the consumer modulator modulates the content for subsequent transmission (e.g., to a consumer receiver).

The effect of this processing is that when content is received by the consumer receiver (from whatever source, either the broadcast facility or the consumer modulator), the consumer receiver will output the content in the clear since a BF is not present. This ensures that other devices downstream, such as digital recorder 66, will check for a watermark in the content. Alternatively, the consumer receiver could output the non-BF content in protected form, with digital CCI set at least as restrictively as the most restrictive possible watermark. Either way, this addresses the problem of a hacker inserting a bad BF into content also containing a more restrictive watermark, and thereby causing recording devices to respond to more permissive digital CCI.

In a third method, the protection logic of the consumer modulator may be required to check for a watermark in the content. If a watermark is found, it may be the broadcast watermark (BW), or another watermark such as may be used with DVDs or other storage formats. If the broadcast watermark is found, then the protection logic of the consumer modulator ensures that a BF is also included in the content (because the BF will be checked by the consumer receiver). If a watermark more restrictive than the broadcast watermark is found in the content (e.g., a “copy never” watermark), then the protection logic of the consumer modulator removes the BF, if present in the content (because processing as a result of the BF should not take priority over processing indicated by the restrictive watermark at the consumer receiver). This may deal with the situation where an invalid BF has been inserted into the content to override the processing of the restrictive watermark. If no watermark is found, the actions of the consumer modulator may be irrelevant.

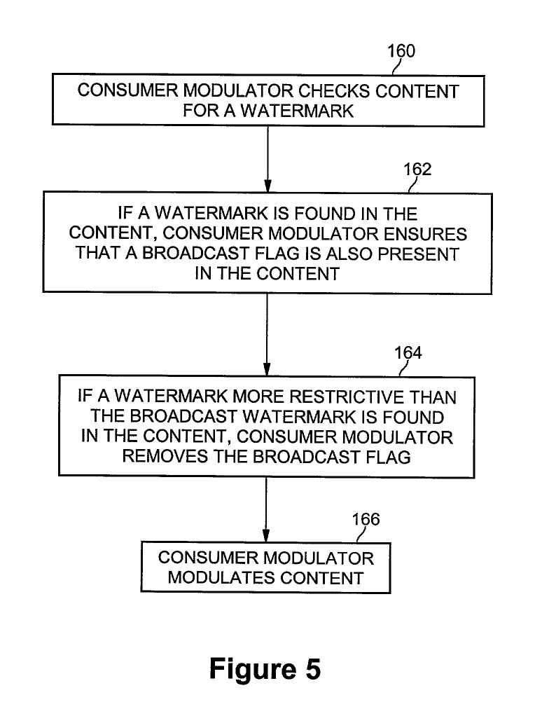

FIG. 5 is a flow diagram illustrating watermark processing in a consumer modulator according to an embodiment of the present invention. At block 160, the protection logic of the consumer modulator checks the content for a watermark. If the protection logic determines that a broadcast watermark (BW) is present in the content, the protection logic of the consumer modulator ensures that a BF is also present in the content at block 162. If a watermark that is more restrictive than the BW is found in the content, the protection logic of the consumer modulator removes the BF, if present in the content, at block 164. At block 166, the consumer modulator modulates the content for subsequent transmission (e.g., to a consumer receiver).

In a system implementing this method, demodulator 60 is required to detect and respond to the BF after demodulation, and protection logic 75 within consumer modulator 74 is required to detect the watermark and insert or remove the BF as needed (as described above), prior to modulation. If a watermark is detected, it could be the BW, in which case the protection logic would insert the BF (if not already present) when the BW was detected. Alternatively, the watermark detected may not be the BW, but another watermark, such as the one that may be used in DVD discs (assuming this is different than the BW), in which case the protection logic would remove the BF (if present), when the watermark was detected in a state (e.g., copy never) that is inconsistent with the BF. In either case, this addresses the insertion attack without requiring a watermark detector in the consumer receiver. This approach addresses the removal attack only in the case where the BW is used (and the content gets re-modulated).

At least one of the three methods described herein may be required to be implemented by a consumer modulator prior to commercial distribution of such a device. In this way, the consumer modulator may work together with application of the BF and/or BW as a signaling mechanism for content protection while deterring unauthorized redistribution of content by other devices in the system.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, consumer electronics, set-top boxes, and other devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g., compact read only memory (CD-ROM), digital versatile disk (DVD), hard disk, magnetic disk, or other medium or device, that is readable by a general or special purpose programmable machine for configuring and operating the machine when the storage medium or device is read by the machine to perform the procedures described herein. The system may also be considered to be implemented as a machine-readable storage medium, configured with a program, where the storage medium so configured causes a machine to operate in a specific manner. Other embodiments are within the scope of the following claims.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method of protecting content from unauthorized redistribution in a content protection system comprising:
verifying, by a modulator device, authenticity of a validated flag, the validated flag comprising a plurality of bits, the validated flag being at least a portion of the content; and
removing, by the modulator device, the validated flag when the validated flag is not authentic.

2. The method of claim 1, wherein the content comprises digital broadcast content.

3. The method of claim 1, wherein verifying authenticity of the validated flag comprises verifying that the validated flag was created by an entity authorized by an owner of the content and that the validated flag corresponds to the content.

4. The method of claim 1, wherein the validated flag comprises a digital signature cryptographically bound to at least a portion of the content.

5. The method of claim 1, further comprising modulating the content.

6. An article comprising: a storage medium having a plurality of machine accessible instructions, wherein when the instructions are executed by a processor, the instructions provide for protecting content from unauthorized redistribution in a content protection system by verifying, by a modulator device, authenticity of a validated flag, the validated flag comprising a plurality of bits, the validated flag being at least a portion of the content, and by removing, by the modulator device, the validated flag when the validated flag is not authentic.

7. The article of claim 6, wherein the content comprises digital broadcast content.

8. The article of claim 6, wherein instructions for verifying authenticity of the validated flag comprise instructions for verifying that the validated flag was created by an entity authorized by an owner of the content and that the validated flag corresponds to the content.

9. The article of claim 6, wherein the validated flag comprises a digital signature cryptographically bound to at least a portion of the content.

10. A modulator device to process content comprising:
protection logic to verify authenticity of a validated flag, the validated flag comprising a plurality of bits, the validated flag being at least a portion of the content, and to remove the validated flag when the validated flag is not authentic; and
a modulator to modulate the content.

11. The modulator device of claim 10, wherein the content comprises digital broadcast content.

12. The modulator device of claim 10, the protection logic to verify that the validated flag was created by an entity authorized by an owner of the content and to verify that the validated flag corresponds to the content.

13. The modulator device of claim 10, wherein the validated flag comprises a digital signature cryptographically bound to at least a portion of the content.

14. A method of protecting content from unauthorized redistribution in a content protection system comprising:
checking, by a modulator device, whether the content includes a broadcast flag, the broadcast flag being at least a portion of the content; and
removing, by the modulator device, the broadcast flag from the content when the broadcast flag is detected in the content.

15. The method of claim 14, wherein the broadcast flag comprises a single bit.

16. The method of claim 14, wherein the content comprises digital broadcast content.

17. The method of claim 16, wherein the content comprises a watermark.

18. The method of claim 14, further comprising modulating the content.

19. An article comprising: a storage medium having a plurality of machine accessible instructions, wherein when the instructions are executed by a processor, the instructions provide for protecting content from unauthorized redistribution in a content protection system by checking, by a modulator device, whether the content includes a broadcast flag, the broadcast flag being at least a portion of the content, and by removing, by the modulator device, the broadcast flag from the content when the broadcast flag is detected in the content.

20. The article of claim 19, wherein the broadcast flag comprises a single bit.

21. The article of claim 19, wherein the content comprises digital broadcast content.

22. The article of claim 21, wherein the content comprises a watermark.

23. The article of claim 19, further comprising instructions for modulating the content.

24. A modulator device to process content comprising:
protection logic to check whether the content includes a broadcast flag, the broadcast flag being at least a portion of the content, and to remove the broadcast flag from the content when the broadcast flag is detected in the content; and
a modulator to modulate the content.

25. The modulator device of claim 24, wherein the content comprises digital broadcast content.

26. The modulator device of claim 25, wherein the content comprises a watermark.

27. A method of protecting content from unauthorized redistribution in a content protection system comprising:
checking, by a modulator device, whether the content includes a watermark, the watermark being at least a portion of the content;
checking, by the modulator device, whether the content includes a broadcast flag when the watermark is found in the content, the broadcast flag being at least a portion of the content; and
removing, by modulator device, the broadcast flag from the content when the watermark found in the content is more restrictive than a broadcast watermark.

28. The method of claim 27, wherein the content comprises digital broadcast content.

29. The method of claim 27, further comprising modulating the content.

30. An article comprising: a storage medium having a plurality of machine accessible instructions, wherein when the instructions are executed by a processor, the instructions provide for protecting content from unauthorized redistribution in a content protection system by checking, by a modulator device, whether the content includes a watermark, the watermark being at least a portion of the content, by checking, by the modulator device, whether the content includes a broadcast flag when the watermark is found in the content, the broadcast flag being at least a portion of the content, and by removing, by modulator device, the broadcast flag from the content when the watermark found in the content is more restrictive than a broadcast watermark.

31. The article of claim 30, wherein the content comprises digital broadcast content.

32. The article of claim 30, further comprising instructions for modulating the content.

33. A modulator device to process content comprising:
protection logic to check whether the content includes a watermark, the watermark being at least a portion of the content, to check whether the content includes a broadcast flag when the watermark is found in the content, the broadcast flag being at least a portion of the content, and to remove the broadcast flag from the content when the watermark found in the content is more restrictive than a broadcast watermark; and
a modulator to modulate the content.

34. The modulator device of claim 33, wherein the content comprises digital broadcast content.
